(19) United States
(12) Patent Application Publication
(10) Pub. No.: US 2008/0201487 A1
(43) Pub. Date: Aug. 21, 2008

(54) OPEN DYNAMIC DOMAIN NAME SYSTEM

(75) Inventors: ARNOLD BLINN, Hunts Point, WA (US); SRIVATHS BADRINATH COPPARAM, Issaquah, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/675,976

(22) Filed: Feb. 16, 2007

(51) Int. Cl. G06F 15/16

(52) U.S. Cl. 709/245; 709/203

(57) ABSTRACT

Assigning subdomain names of domain names to users and allowing the subdomain names to receive dynamic Domain Name System (DNS) service is described herein. A downloadable application is configured to submit the domain name as well as subdomain names for registration. The owner of the domain name can other users to receive a subdomain name by granting permission thereto. Requesting users can then receive a subdomain if the owner allows. Dynamic DNS services are then administered for the subdomain, regardless of the domain owner's authorization.

### BACKGROUND

A domain name is a network address that identifies a computer or network that is connected to the Internet. Domain names typically include different domain name levels. A period separates the higher levels from lower levels. The level farthest to the right of the domain name is called the top-level domain (TLD), and it generally comprises a two- or three-letter descriptor (e.g., com, org, net, uk, or us) approved by the Internet Corporation for Assigned Names and Numbers (ICANN). Subsequent levels of the domain name are located in descending order to the left of previous levels. For purposes of the discussion herein, domain names are referred to as only the combination of level one and level two domain names, such as “microsoft.com.” Meanwhile, domain-name levels greater than two will be referred to as subdomains. For example, the web page one.two.microsoft.com contains a domain, “microsoft.com,” and two subdomains, “two.microsoft.com” and “one.two.microsoft.com.”

Every time a user requests a domain name, one or more domain name system (DNS) servers translate the domain name into a machine-readable IP address. Many times, however, the IP address for a given machine may change. Servers typically have static IP addresses that do not change very often, but a home machine that is connected to the Internet through a modem often has an IP address that is assigned by an internet service provider (ISP). Consequently, the IP address of the home machine may be different for each session of internet connectivity. Typically, this is referred to as a dynamic IP address. Dynamic DNS services can help map these dynamic IP addresses to the associated domain names' current IP addresses. DNS servers, however, only provide dynamic DNS service to the owner of the single domain.

Rights to use a single domain name, as well as all subdomain names, are transferred exclusively to a single entity. This entity becomes the owner of the particular domain name. For convenience, the licensee will be referred to herein as the “owner” to be consistent with general nomenclature in the art. Domain name vendors do not license rights to subdomains. However, users of subdomains have limited rights, because the right to control the subdomain lies with the owner. The owner of a single domain name, and all subdomain names thereof, may allow other users to utilize a subdomain name of their single domain name. For example, an owner of a web site (e.g., “valuablebaseballcards.com”) could allow a friend to create a web page for a subdomain (e.g., “baberuth.valuablebaseballcards.com”). Consequently, an owner of this subdomain cannot receive dynamic DNS service for the subdomain, unless he or she was the owner of the corresponding domain, and a subdomain user may have problems with Internet connectivity.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter

Some embodiments described herein relate to creating a subdomain name of a domain name. The domain name is associated with an IP address for a computing device. An application can be downloaded onto a client or remote computing devices and is configured to submit the domain name as well as subdomain names for registration. Requests for approval of subdomain names are submitted by users through the application. The owner of the domain name approves the requests, granting users ownership of subdomain names. Alternatively, the owner of the domain may pre-approve all requests for subdomains. Once a user receives a subdomain name, the subdomain is automatically registered to receive dynamic DNS services.

Other embodiments described herein relate to various modules that can associate a subdomain with a user and enable dynamic DNS service be provided to the subdomain. A client application is configured to submit a request from a domain name owner to allow users to gain access to subdomain names. A remote application is configured to submit a request from a secondary user to register for a subdomain name. A domain module determines whether the first user will allow association of the subdomain name with the domain name, and, if so, a sign-up module registers the subdomain name and associated IP address. Updated IP addresses for the subdomain can then be transmitted from a remote computing device to a server.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary operating environment for use in implementing an embodiment of the present invention;

FIG. 2 is a block diagram of a networking environment for use in implementing an embodiment of the present invention;

FIG. 3 is a flowchart illustrating a process for registering a domain name that other users may create subdomain names therefrom, according to an embodiment of the present invention;

FIG. 4 is a flowchart illustrating a method for associating a subdomain name with a domain name, according to an embodiment of the present invention; and

FIG. 5 is a flowchart illustrating a method for registering a subdomain name to receive dynamic DNS services, according to an embodiment of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

In general, embodiments described herein generally relate to allowing a plurality of users to create subdomains stemming from a single domain managed by an owner. For example, a user named John owns a domain called john.com. It could be used to register subdomains for John's sister and father (e.g., dad.john.com and sister.john.com). The registered subdomains would provide a human-readable address, which could be translated into an IP address by a DNS service. In one embodiment, the owner of the single domain is able to add, manage, and delete subdomains of the owner's domain.

Some embodiments described herein also relate to providing dynamic DNS service to the subdomains of a domain. As previously mentioned, conventional dynamic DNS services are only provided to owners of domain names. Also, only owners can set up domains to receive dynamic DNS service. In one embodiment, a user can download an application from a web site that enables a user to register a subdomain underneath a domain name and receive dynamic DNS service for the subdomain, without authorization from the owner. Thereafter, the dynamic DNS service may be used to update a DNS server with dynamic IP addresses associated with the subdomain.

Domain names and subdomain names, as discussed herein, refer to stored web pages. Rather, either a domain name or a subdomain name refers to a user-friendly address of any computing device on the Internet. For example, jill.doe.com could represent the address of Jill's home computer. In such an example, a user could access Jill's home computer by making a request, using a protocol, with a uniform resource locator (URL) that includes the subdomain jill.doe.com. Examples of protocols that can be used to access various type of information over the Internet include, without limitation, the hypertext protocol (HTTP), file transfer protocol (FTP), secure sockets layer (SSL), and secure http (HTTPS).

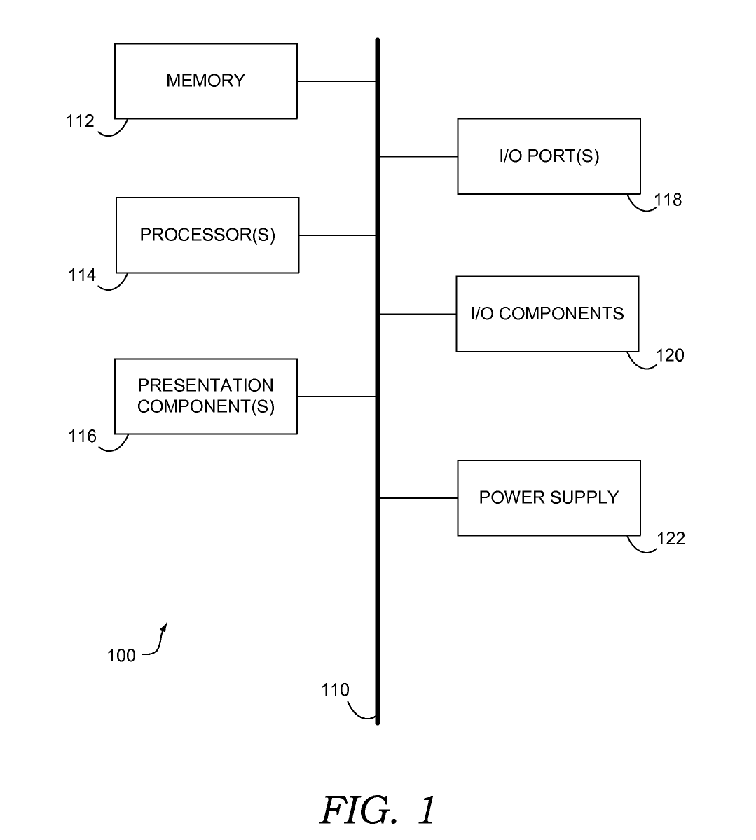

Having described a general overview of the embodiments described herein, an exemplary operating environment is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), digital music player, game console, or other device capable of executing computer instructions.

Some embodiments may be described in the general context of computer code or machine-useable instructions, including computer-executable instructions such as program modules, being executed by a computer or other machine, such as a PDA or other handheld device. Generally, program modules including routines, programs, objects, components, data structures, and the like, refer to code that perform particular tasks or implement particular abstract data types. Each module described herein may represent executable source code written in a well-known language, such as, for example, C, C++, C#, Java, or the like. In addition, each module described herein may be embodied, at least in part, as an application program interface (API) or script. Embodiments described herein may be practiced in a variety of system configurations, including hand-held devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, network cards (e.g., a network interface controller (NIC)), wireless cards, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

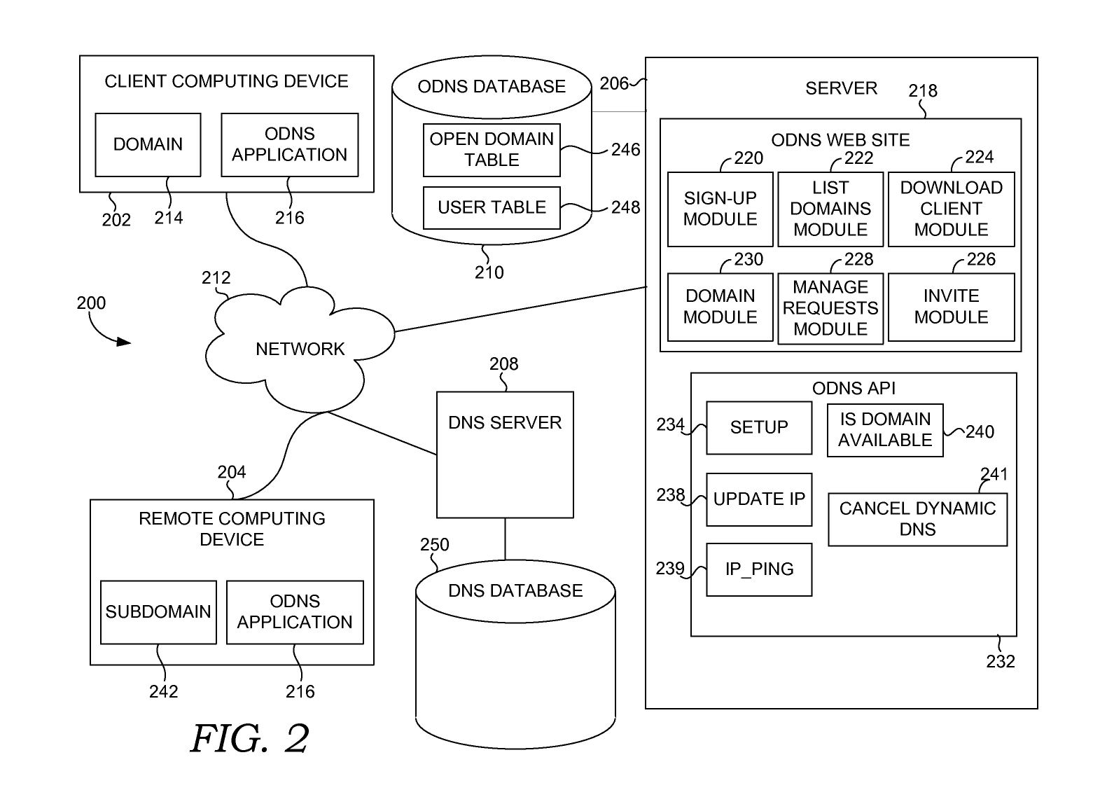

Turning now to FIG. 2, a block diagram depicting a networking architecture 200 is shown for use in implementing an embodiment. The networking architecture 200 comprises a client computing device 202, a remote computing device 204, a server 206, a DNS server 208 coupled with a DNS database 250, and an open DNS (ODNS) database 210, all of which are configured to communicate with each other via network 212. Networking architecture 200 is merely an example of one suitable networking environment and is not intended to suggest any limitation as to the scope of use or functionality. Neither should networking architecture 200 be interpreted as having any dependency or requirement related to any single component or combination of components illustrated therein.

The client computing device 202 and the remote computing device 204 may be any type of computing device, such as device 100 described above with reference to FIG. 1. By way of example only and not limitation, the client computing device 202 and the remote computing device 204 may be a personal computer, desktop computer, laptop computer, handheld device, cellular phone, digital phone, smartphone, PDA, or the like. It should be noted that embodiments are not limited, however, to such computing devices.

Network 212 may include any computer network or combination thereof. Examples of computer networks configurable to operate as network 212 include, without limitation, a wireless network, landline, cable line, digital subscriber line (DSL), fiber-optic line, local area network (LAN), wide area network (WAN), metropolitan area network (MAN), or the like. Network 212 is not limited, however, to connections coupling separate computer units. Rather, network 212 may also comprise subsystems that transfer data between servers or computing devices. For example, network 212 may also include a point-to-point connection, the Internet, an Ethernet, an electrical bus, a neural network, or other internal system.

In an embodiment where network 212 comprises a LAN networking environment, components are connected to the LAN through a network interface or adapter. In an embodiment where network 212 comprises a WAN networking environment, components use a modem, or other means for establishing communications over the WAN, to communicate. In embodiments where network 212 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The server 206 may be any type of application server, file server, or other well-known server configurable to perform the methods described herein. In addition, the server 206 may be either a dedicated or shared server. One example, without limitation, of a server that is configurable to operate as the server 206 is a PowerEdge® server manufactured by Dell, Inc®. The server 206 may also be configured to run server software, such as SQL Server 2005, which was developed by the Microsoft® Corporation, or Apache HTTP Server Project, developed by the Apache Software Foundation®.

Components of the server 206 may include, without limitation, a processing unit, internal system memory, and a suitable system bus for coupling various system components, including one or more databases for storing information (e.g., files and metadata associated therewith). The server 206 may also include, or be given access to, a variety of computer-readable media. By way of example, and not limitation, computer-readable media may include computer-storage media and communication media. In general, communication media enables each server to exchange data via network 212. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The DNS server 208 is a server capable of translating a domain name into a web address and, in some embodiments, vice versa. In one embodiment, the DNS server 208 is electrically coupled to the DNS database 250. The DNS database 250 stores, in some embodiments, various resource records, zones, and other information used for DNS services. One skilled in the art will understand the inner-workings of the DNS server 208.

In an embodiment, the server 206 is electrically coupled to the ODNS database 210. The DNS database 250 and the ODNS database 210 are database management servers that may be set to organize data and respond to queries as either a relational database or an object-relational database. While the server 206, the DNS server 208, the DNS database 250, and the ODNS database 210 are illustrated as single units in FIG. 2, one skilled in the art will appreciate that they each are scalable. For example, the server 206 may in actuality include a plurality of servers in communication. The single unit depictions are meant for clarity, not to limit the scope of embodiments.

The client computing device 202 comprises a domain 214 and an ODNS application 216. The domain 214 is a domain name associated with the client computing device 202. In an alternative embodiment, not depicted in FIG. 2, the domain 214 is located on a web server that stores one or more web pages. In one embodiment, a user of the client computing device 202 may wish to register the domain 214 with a domain registrar (e.g., Go Daddy®, Network Solutions®, or the like). Once the domain 214 is registered, the user is known as the owner of the domain 214.

The remote computing device 202 comprises a subdomain 242 and an ODNS application 216. The subdomain 242 is a subdomain name pointing to the remote computing device 204. Moreover, the subdomain 242 subtends the domain 214, meaning the subdomain 242 includes a higher level domain than the domain 214. For example, the subdomain 242 may be john.jane.doe, and the domain 214 would be jane.doe. In an alternative embodiment, not depicted in FIG. 2, the subdomain 242 is located on a web server that stores a web page.

The ODNS application 216 is downloadable from the server 206 and serves to facilitate communication with a dynamic DNS service (not shown in FIG. 2 for clarity). The dynamic DNS service may be on the DNS server 208 or the server 206. Once installed on either the client computing device 202 or the remote computing device 204, the IP addresses assigned to the domain 214 and the subdomain 242 may be broadcast, in one embodiment, to the DNS server 208 or the server 206.

For a variety of reasons, it may be advantageous for the owner to allow others to establish subdomains from the domain 214. For example, an owner may buy a domain (doe.com) that points to her personal computer and allow her brother to create a subdomain (john.doe.com) that points to his personal computer. The owner can easily access her brother's personal computer by submitting an http request with the domain name. This may enable the sister to view the brother's photographs or listen to his music. In another example, a small business may wish to create subdomains pointing to work computers in order to easily access company files over the Internet. In still another example, a particular domain name may be quite popular to many people. For example, a plethora of users may wish to have their own subdomain of hardcoreseattleseahawksfans.com.

As previously mentioned, conventional dynamic DNS services are not available for a subdomain unless a domain owner authorizes them. While this may pose a problem when the subdomain is associated with dynamic IP addresses. The IP addresses of the subdomain may not be recorded when they change. If the IP address is changed but not stored, the corresponding subdomain name cannot be associated with the correct IP address. As a result, requests for connection to the subdomain—such as, when a user wishes to view a web page—cannot be fulfilled.

The owner can access an interactive web site (the ODNS web site 218), which is hosted on the server 206, to allow subdomains (e.g., the subdomain 242) to be reserved under the domain 214. In an embodiment, the ODNS web site 218 allows users to register subdomains for dynamic DNS services without owner authorization. The ODNS web site 218 comprises a sign-up module 220, list domains module 222, download client module 224, domain module 230, manage requests module 228, and invite module 226. In operation, these six modules utilize the following application programming interfaces (APIs): setup API 234, update IP API 238, IP_Ping API 238, IsDomainAvailable API 240, and CancelDynamicDNS API 241. In one embodiment, the aforementioned modules and APIs reside on the server 206.

The setup API 234 is configured to assign the subdomain 242 to the secondary user. In operation, the setup API 234 receives the domain 214 or the subdomain 242 as inputs and creates a secure token string based on a user-verification information. In an embodiment, the secure string is stored on the ODNS database 210 in a user table 248. The user table 248 stores a plurality of records detailing the association of users and domains or subdomains. For example, the setup API 234 might store a string with indications that the owner is affiliated with the domain 214.

The update IP API 238 is configured to receive secret DNS tokens and updated IP addresses, and assign the updated IP addresses to the corresponding domain or subdomain. In operation, the update IP API 238 provides dynamic DNS service to domains and subdomains registered at the ODNS web site 218. In an embodiment, the update IP API 240 stores the updated IP address along with an association to the subdomain specified by the DNS token in a record on the user table 248. For example if john.jane.doe originally had an IP address of 123.234.122.155 that later was assigned 234.101.115.102, the latter address would replace the prior address in the record. As a result, subdomains with dynamic IP addresses can be automatically updated without authorization from the owner.

The IsDomainAvailable API 240 is configured to check the availability of a particular subdomain name. In other words, this API determines whether a requested subdomain is available for reserving. In one embodiment, this is done by querying the ODNS database 210, which accesses an open domain table 246. A record of available subdomains may be stored in an open domain table 246 on the ODNS database 210. Subdomains are considered available when they are registered through the sign-up module 220 (discussed below) but not assigned to a user.

The IP_Ping API 239 is configured to retrieve the IP address of a computing device. In operation, the IP_Ping API 239 receives the IP address of the computing device by either pinging the computing device or requesting the IP address from the DNS server 208. Any of the modules or APIs discussed herein may communicate with the IP_Ping API 239 to determine IP addresses for computing devices. In one embodiment, the update IP API 238 utilizes the IP_Ping API 239 to check whether an IP address for a computing device has changed. If so, the IP address retrieved by the IP_Ping API 239, in one embodiment, is communicated to the update IP API 238, which then stores the new IP address in either the ODNS database 210 or the DNS database 250. One skilled in the art will understand that various methods exist for retrieving a computing device's IP address, and embodiments described herein are not limited to any particular method of pinging a computing device.

The CancelDynamicDNS API 241 is configured to terminate a dynamic DNS service for a given subdomain. For example, an owner of the remote computing device 204 may wish to cancel a dynamic DNS service for the remote computing device 204 if the subdomain 242's IP address becomes static. Or the price of the dynamic DNS service may compel the owner to cancel the service. Regardless of the reason, the user may initiate the CancelDynamiDNS API 241, in one embodiment, by selecting a cancellation option on the ODNS web site 218.

The sign-up module 220 is configured to register the subdomain 242 with the domain 214 if the domain module 230 (discussed below) determines the owner will allow the subdomain 242 to be associated with the domain 214. In one embodiment, the owner submits a request to the server 206 to register the domain 214 with a web service. The request may include various user-verification information about the owner. User-verification information may include, for example, a user name, password, street address, geographic location, date of birth, maiden name, social security number, or relationship information (e.g., brother, sister, married, single, etc.). In addition, the request may also include information about the domain 214, including: domain name, IP address, proof of ownership, etc. The sign-up module 220 receives the request from the user and determines whether to allow subdomains to other users. Such a determination is made by authenticating the owner with the user-verification information and determining whether the owner actually owns the domain 214. Additionally, the owner may designate whether the domain 214 is a static or dynamic IP address.

In another embodiment, the owner submits restrictions to the server 206 to limit the users who can receive a subdomain of the domain 214. For example, the owner may only wish to allocate subdomains to family members. An owner of a domain for a particular business may only wish to grant subdomains to employees or for specific computing devices—such as a work research computer. In one embodiment, the owner selects restrictions presented on the ODNS web site 218. In another embodiment, the owner submits restrictions that are stored on the client computing device 202 (e.g., an address list in an e-mail messenger) to the signup module 220. Alternatively, the owner may specify subdomains that cannot be allocated. Moreover, the owner may require users to pay a fee for a subdomain. Restrictions may also include, for example, a geographic location, street address, name, age, user authentication, or any other user information. One skilled in the art will understand that various restrictions or similar parameters may by submitted or used to register the domain 214.

A user of the client computing device 204 (hereinafter referred to as the secondary user) may submit a request to receive the subdomain 242 from the domain 214. The secondary user's request may include any of the aforementioned user-verification information as well as information relevant to any restrictions. In addition, the secondary user may also be prompted for the name of the subdomain 242.

The owner may eliminate the need for the secondary user to request the subdomain 242. In one embodiment, the owner pre-approves all requests for subdomains of the domain 214. Thereafter, any user requesting a subdomain is automatically approved without having to meet any restrictions. A pre-approved list of users who may obtain a subdomain may be developed by the owner and stored on the server 206. Any user requesting the subdomain 242 who is on the pre-approved list will automatically be given the subdomain 242. Alternatively, the owner may require a fee before allocating the subdomain 242. Embodiments are not limited to any particular registration process, as one skilled in the art will understand that many different methods can be used.

The list domains module 222 lets users view subdomains that are pre-approved for them to buy or acquire. In one embodiment, the list domains module 222 uses the IsDomainAvailable API 240 to determine which subdomains are currently available. The IsDomainAvailable API 240 may determine this by querying the ODNS database 210 to access the open domain table 246. For each returned, available subdomain, the list domain module 222 determines whether a requesting user is restricted by the owner. In one embodiment, all the subdomains that the requesting user is not restricted from and that are available are then returned.

The download client module 224 transmits the executable machine code of the ODNS application 216 to either the client computing device 202 or the remote computing device 204 for installation. The ODNS application 216 is configured to determine whether the IP address of either the domain 214 or the subdomain 242 has been modified. If so, the ODNS application 216 is configured to transmit updated IP addresses to the server 206 so the stored IP addresses of the domain 214 or the subdomain 242 can be saved. If either the domain 214 or the subdomain 242 includes a static IP address (i.e., one that does not change), the IP address is only transmitted once to the server 206.

The domain module 230 is configured to retrieve the request for the subdomain 242 and determine whether the owner has approved allocating the subdomain 242 to the secondary user. Such a determination is made by comparing information submitted by the secondary user with the restrictions placed by the owner or against a pre-approval list submitted by the owner. If the owner pre-approves the secondary user, the subdomain 242 is assigned to the secondary user. In one embodiment, the owner requires that the secondary user submit additional information, such as, for example, name, geographic location, street address, plans for the subdomain, or any other type of information. The domain module 230 may be configured to create a list of users who wish to obtain one or more subdomains of the domain 214. This list may be presented to the owner who may then determine which subdomains to allocate and what users should receive them.

The manage requests module 228 is configured to present to the owner requests for subdomains from secondary users if the owner has not pre-approved subdomain allocation. The owner may then select entities or users to receive subdomains.

The invite module 226 may be configured to invite the secondary user to obtain the subdomain 242. An e-mail message with detailed instructions on how to pick up the subdomain 242 may be sent to the secondary user. The detailed instructions are particularly helpful for users who are not computer savvy. Other forms of communication may also be initiated by the invite module 226. For example, an instant message, voice mail, phone call, or other type of notification can be sent as well. Embodiments are not limited thereto; rather, one skilled in the art will understand that numerous methods exist for communicating such an invitation to a user.

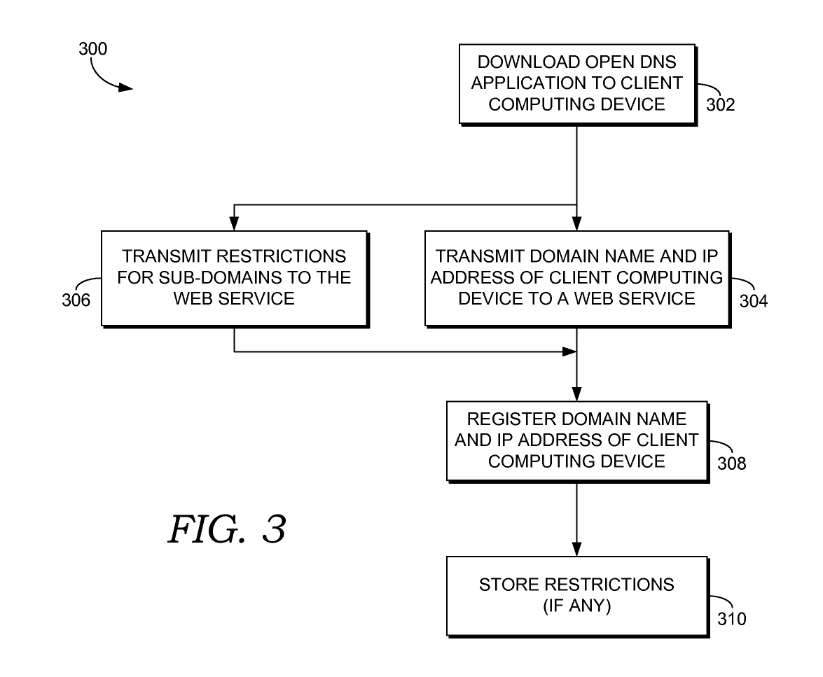

Turning now to FIG. 3, a process 300 is presented for registering a domain name that users can use to acquire subdomain names therefrom, according to an embodiment of the present invention. An application (such as the ODNS application 216) is downloaded to the owner's client computing device, as illustrated at block 302. In one embodiment, the application transmits the domain name and related IP address to a server executing a web service for storing such information, as illustrated at block 304. The application may also be configured to identify which subdomain names of the domain name can be allocated to other users. The owner may select to pre-approve all requests for subdomain names or can submit restrictions through the application.

The domain name and IP address of the client computing device are transmitted to a server that will store such information, as illustrated at block 306. Once stored, the domain name and IP address are registered with the server, as illustrated at block 308. Updated IP addresses may subsequently be transmitted to account for dynamic IP addresses.

The owner can then submit a request to share the subdomain names of the domain name with one or more other users. If the owner specifies any restrictions for assigning subdomain names, such restrictions are stored, as illustrated at block 310. For example, the owner may only wish to grant certain domain names or only grant subdomains to specific people.

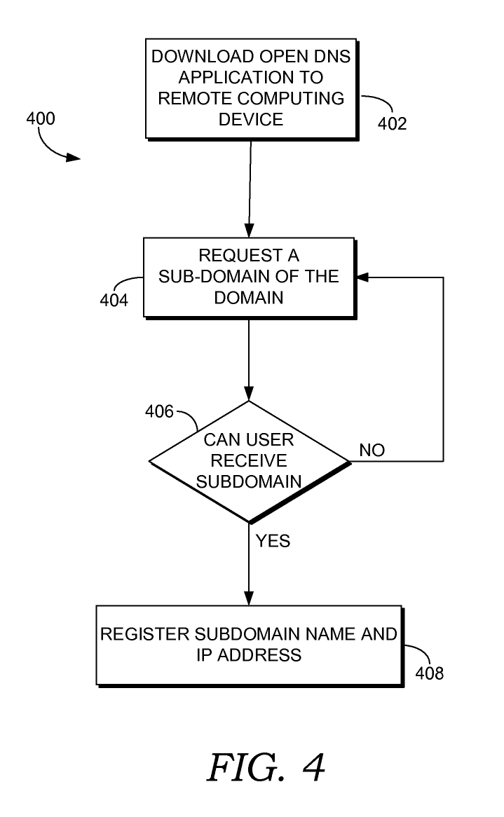

Referring to FIG. 4, a process 400 is presented for associating a subdomain name with a domain name, according to an embodiment of the present invention. Initially, the DNS application is downloaded to a remote computing device, as illustrated at block 402. A secondary user can submit a request for a subdomain, as illustrated at block 404. The request may identify a particular subdomain, domain name, or owner. In addition to the request, user-verification information about the secondary user is also submitted to authenticate the secondary user, as illustrated at block 404. For example, the secondary user's username, password, name, or date of birth may be submitted to a server for verification.

Next, it is determined whether the secondary user can receive the subdomain name, as illustrated at decision block 406. A domain module (e.g., the domain module 230 discussed above) can be configured to determine whether the owner will grant the secondary user the subdomain. The owner can be notified of the secondary user's request and asked to decide whether to give the secondary user the subdomain. In addition, the domain module may be configured to determine whether the secondary user has been restricted by the owner.

If the secondary user is not approved, the subdomain is not allocated, as indicated by the NO path from decision block 406. If the secondary user is approved, the subdomain name and IP address are then registered by a server, as illustrated at block 408. Updated IP addresses associated with the subdomain name can then be transmitted through the ODNS application to accommodate dynamic IP addresses of the subdomain.

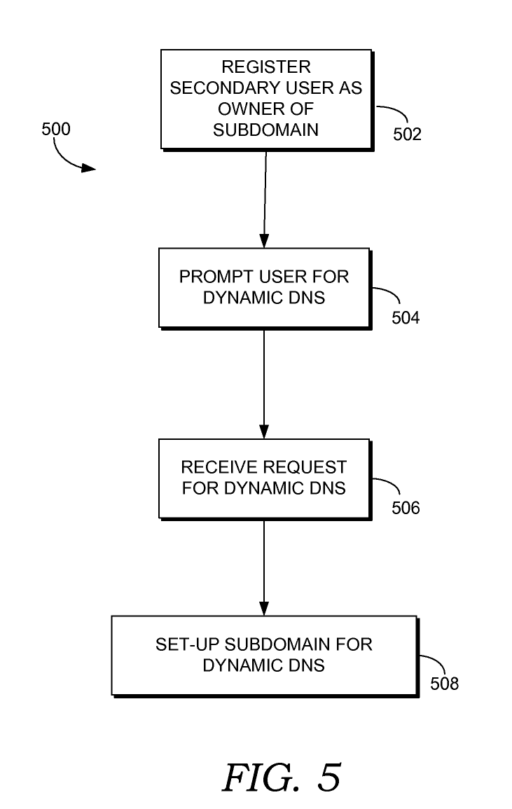

Referring to FIG. 5, method 500 is presented for registering a subdomain name to receive dynamic DNS services, according to an embodiment of the present invention. Once the secondary user receives the subdomain, the subdomain is registered to the secondary user, in one embodiment, by the server 206. The secondary user is thus considered to be the owner of the subdomain. The server 206 may store registration information for the subdomain in the user table 248 of the ODNS database 210. Registration information may include, for example, without limitation, machine-readable values for the name, date of birth, social security number, or other indication of the secondary user. Embodiments should not be limited to any type of registration information, however, as one skilled in the art will understand that various attributes of the secondary user, domain name, and IP address can be used.

Once the subdomain is registered to the secondary user, the secondary user may be prompted to obtain a dynamic DNS service, as illustrated at block 504. A web site, such as the ODNS web site 218, may present an option for registering to receive dynamic DNS service to the secondary user. The secondary user can request the dynamic DNS service by selecting such an option on the web site, as indicated at block 506. No authorization from the owner of the domain from which the subdomain subtends is required to register the subdomain for the dynamic DNS service.

If the secondary user requests the dynamic DNS service, the subdomain is configured to receive the dynamic DNS service, as illustrated at block 508. Once registered to receive the dynamic DNS service, the remote computing device 204 can transmit updated IP addresses to the server 206, or, alternatively, to the DNS server 208. The updated IP addresses include new IP addresses assigned to the subdomain. For example, if the IP address of the subdomain is changed from 123.45.110.90 to 102.56.178.201, the latter IP address is transmitted. In one embodiment, the ODNS application 216 transmits an updated IP address to the server 206. The server 206 may be configured to receive the updated IP address using the update IP API 238. The server 206 may also be configured to store the updated IP address in the user table 248 or transmit the updated IP address to the DNS server 208 for storage as a record resource. Moreover, updated addresses may be communicated from the remote computing device 204 to the server 206 using any type of push, pull, push-pull, broadcast, or poll method. For example, the remote computing device 204 may broadcast the updated IP address to the server immediately, or the server 206 may periodically request the IP address of the subdomain. One skilled in the art will understand that numerous methods exist for receiving updated IP addresses.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon for the creation of a subdomain name of the domain name, wherein the domain name is associated with a first internet protocol (IP) address for a computing device, comprising:
downloading an application onto a remote computing device, wherein the application is configured to submit the subdomain name for registration with the domain name;
requesting approval of the subdomain name;
submitting user-verification information to identify a user requesting the approval of the subdomain name; and
transmitting a second IP address associated with the subdomain name.

2. The one or more computer-readable media of claim 1, wherein the user-verification information includes at least one of a user name, a password, a street address, a geographic location, or a relationship indication.

3. The one or more computer-readable media of claim 1, further comprising:
determining whether the second IP address has been modified; and, if so,
transmitting a modified IP address to be associated with the subdomain.

4. The one or more computer-readable media of claim 1, wherein the subdomain name can be translated by a domain name system (DNS) server into the second IP address.

5. The one or more computer-readable media of claim 1, wherein the second IP address includes a virtual address of a computing device.

6. The one or more computer-readable media of claim 1, wherein the second IP address includes an address associated with the client computing device.

7. The one or more computer-readable media of claim 6, wherein a request of the subdomain name enables one or more users to access at least a portion of information stored on the remote computing device by submitting a uniform resource locator (URL) comprising the subdomain name.

8. The one or more computer-readable media of claim 1, further comprising the user receiving an electronic mail (e-mail) message requesting that the user create the subdomain name.

9. One or more computer-readable media having computer-executable modules for creating a subdomain name of the domain name, wherein the domain name is associated with a first internet protocol (IP) address for a computing device, comprising:
a client application configured to submit a first request from a first user that one or more subdomain names be associated with the domain name;
a remote application configured to submit a second request from a second user that the subdomain name be registered as a subtending name of the domain name;
a domain module configured to determine whether the first user will allow association of the subdomain name with the domain name; and
a sign-up module configured to register the subdomain name with the domain name if the domain module determines the first user will allow the subdomain name to be associated with the domain name.

10. The one or more computer-readable media of claim 9, wherein the second request includes at least a second IP address associated with the subdomain name.

11. The one or more computer-readable media of claim 9, wherein the second request includes a static internet protocol (IP) address related to a second computing device.

12. The one or more computer-readable media of claim 9, further comprising a pre-approved list of one or more users specified by the first user to be automatically granted a subdomain name of the domain name, wherein the subdomain name is automatically approved to be registered under the domain name if the domain module determines the second user is indicated on the pre-approved list.

13. The one or more computer-readable media of claim 9, further comprising
an update module configured to transmit an updated IP address assigned to the subdomain name if a second IP address associated with the subdomain name is dynamically changed; and
an update-IP module configured to store the updated IP address on a server.

14. The one or more computer-readable media of claim 9, further comprising a verification module configured to utilize user-verification information submitted by a remote computing device to authenticate the second user.

15. The one or more computer-readable media of claim 9, further comprising a domain-availability module configured to determine at least one subdomain name that is pre-approved to be registered under the domain name.

16. The one or more computer-readable media of claim 9, further comprising an invite module configured to transmit an electronic mail (e-mail) message to the second user, wherein the e-mail message invites the second user to register the subdomain name.

17. The one or more computer-readable media of claim 9, further comprising a database configured to store a table that includes at least the subdomain name, an indication of the first user, and an indication of the second user.

18. A method in a computer system for allowing a subdomain to receive dynamic DNS service without authorization from an owner of a domain, comprising:
receiving notification of the subdomain registration;
prompting a secondary user to register the subdomain for the dynamic DNS service, wherein the secondary user is not the owner of the domain;
receiving a request from the user to register the subdomain for the dynamic DNS service; and
registering the subdomain for the dynamic DNS service.

19. The method of claim 18, wherein the dynamic DNS service associates the subdomain with updated internet protocol (IP) addresses whenever a new IP address is assigned to the subdomain.

20. The method of claim 18, wherein registering the subdomain for the dynamic DNS service comprises notifying a server administering the dynamic DNS service to provide the dynamic DNS service to the subdomain.
